(19) United States
(12) Patent Application Publication
(10) Pub. No.: US 2016/0196023 A1
(43) Pub. Date: Jul. 7, 2016

(54) SYSTEMS, METHODS, AND APPARATUS FOR ADMINISTRATOR TOOL HIGHLIGHTING

(71) Applicant: Facebook, Inc., Menlo Park, CA (US)

(72) Inventors: Tony Hsien-yu Liu, Palo Alto, CA (US); Yuankai Ge, San Mateo, CA (US); Barton David Smith, New York, NY (US); Paritosh Aggarwal, Sunnyvale, CA (US); Daniel Dinu, Cupertino, CA (US)

(21) Appl. No.: 14/589,877

(22) Filed: Jan. 5, 2015

(51) Int. Cl. G06F 3/0484; G06F 3/0482; H04L 29/06

(52) U.S. Cl. CPC G06F 3/0484; H04L 65/403; G06F 3/0482

(57) ABSTRACT

Exemplary methods, apparatuses, and systems for highlighting an administrator tool are describe. In some embodiments, an administrator tool highlighting engine receives a plurality of signals, at an administrator tool highlighting engine executing on a hardware processor, relating to at least one of a social networking page, behavior of an administrator of the page, and a user base of the page, determines an administrator tool to highlight based on the signals, generates a graphical user interface highlighting the administrator tool, and provides the graphical user interface to a user.

### FIELD

The various embodiments described herein relate to administrator tools. In particular, the embodiments relate to highlighting an administrator tool in a collection of available administrator tools.

### BACKGROUND

Social networking systems enable users to interact with various objects represented within the social network. For example, a social networking system allows users to designate other users or entities as connections (or otherwise connect to, or form relationships with, other users or entities), contribute and interact with their connections, post media or commentary, share links to external content, use applications, join groups, list and confirm attendance at events, invite connections, and perform other tasks that facilitate social interaction. External applications also use the services of a social networking system to allow authenticated users to incorporate some of the above social interactions with use of the external applications. Similar interactions may also be a part of the user experience within other network services.

### SUMMARY OF THE DESCRIPTION

Exemplary methods, apparatuses, and systems for highlighting an administrator tool are described. Administrator tools an administrator of a page accomplish an objective such as adding more followers, reaching a wider audience, etc. In some embodiments, an administrator tools include tools that 1) help get more social interaction (e.g., likes, reposts, comments, etc.); 2) provide a mechanism for inviting a friend; 3) provide a mechanism for inviting email contacts; and 4) provide a mechanism for sharing the page.

In one embodiment, an administrator tool highlighting engine receives signals relating to at least one of a social networking page, behavior of an administrator of the page, and a user base of the page to be used in determining which administrator tool to highlight. The administrator tool highlighting engine may also use an express objective in making this determination. Once an administrator tool is selected for highlighting, a graphical user interface highlighting the administrator tool is provided to a user.

Other features and advantages will be apparent from the accompanying drawings and from the detailed description.

### BRIEF DESCRIPTION OF THE DRAWINGS

The present invention is illustrated by way of example and not limitation in the figures of the accompanying drawings, in which like references indicate similar elements, and in which:

FIG. 1 illustrates an example network environment of a system 100 including a social networking system;

FIG. 2 illustrates exemplary graph 200 of social network data;

FIG. 3 illustrates an embodiment of a graphical user interface (GUI) of a page provided by a social networking system to a user;

FIG. 4 illustrates an exemplary block diagram of a social networking system and its administrator tool highlight engine;

FIG. 5 illustrates an embodiment of an administrator tool highlight rule set;

FIG. 6 illustrates an embodiment of a method executed by a social networking system for providing tool highlights to a user;

FIG. 7 illustrates an embodiment of a method executed by a social networking system for providing tool highlights; and

FIG. 8 illustrates, in block diagram form, an exemplary processing system to perform administrator tool highlighting.

### DETAILED DESCRIPTION

Social networking systems benefit from techniques that improve an ability of users to share online content with other users of the social networking system. These users may share content by sending or posting electronic messages (posts) to the social networking system for display that include text or images associated with other users of the social networking system. Accordingly, through the use of posts, different users are able to interact with each other. Unfortunately, not all posts have a desired outcome. For example, some posts do not reach the intended audience because of one of several factors including, but not limited to: timing, subject matter, formatting and/or rendering, wrong audience, etc. Discussed below are systems, apparatuses, and methods for better administrator tool highlighting to promote the page.

In the following description, numerous specific details are set forth. However, it is understood that embodiments of the invention may be practiced without these specific details. While a social networking system is used to describe embodiments of preview generation for online content, it will be understood that these concepts are generally applicable to generating previews for online content for other network services/entities, websites, etc. References in the specification to “one embodiment,” “an embodiment,” “an exemplary embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

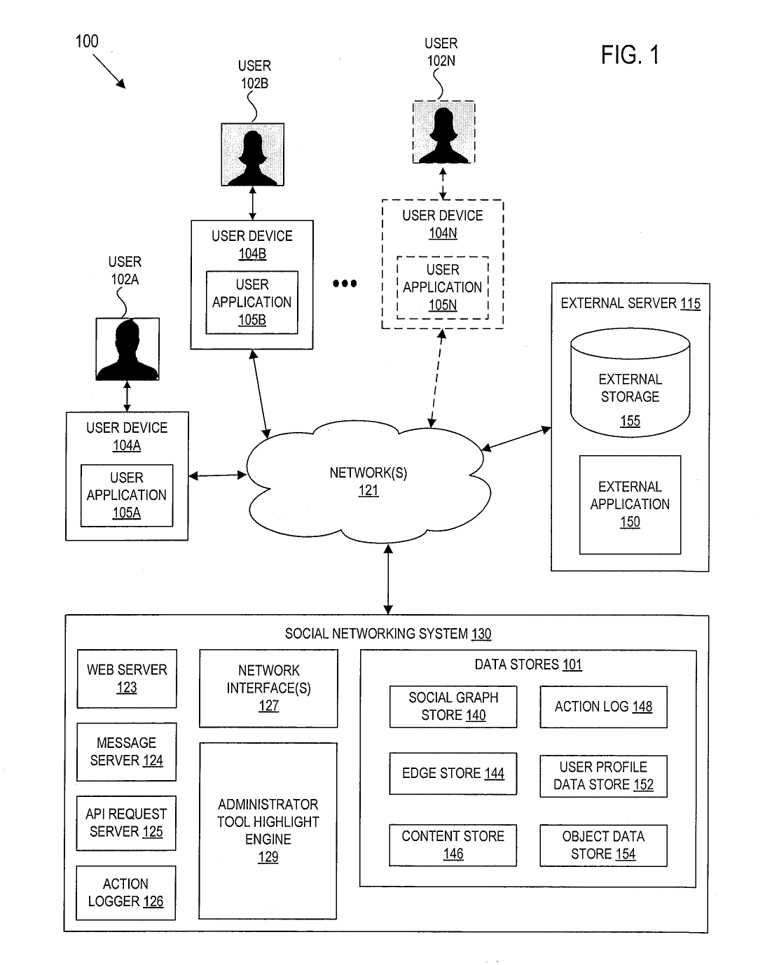

FIG. 1 illustrates an example network environment of a system 100 including a social networking system 130 that offers its users 102A-102N the ability to communicate and interact with other users 102A-102N and entities of the social networking system 130 according to an embodiment of the invention. The illustrated social networking system 130 includes a content creator identification analysis module 129 for automatically identifying content creators from resources shared between users of the social networking system in accordance with an embodiment of the invention.

In some embodiments, the social networking system 130 comprises one or more computing devices storing user profiles associated with users 102A-102N and/or other objects, as well as connections between users and other users 102A-102N and/or objects.

The user devices 104A-104N that are enabled to interact with social networking system 130 can be any type of computing device capable of receiving user input as well as transmitting and/or receiving data via a network (e.g., network 121). For example, the user devices 104A-104N can include conventional computer systems, such as a desktop or laptop computer, or may include devices having computer functionalities such as Personal Digital Assistants (PDA), cellular or mobile telephones, smart-phones, in- or out-of-car navigation systems, gaming devices, or other electronic devices.

In one embodiment, a user device (e.g. 104A) may execute a user application (e.g. 105A) allowing a user 102A of the user device 104A to interact with the social networking system 130. For example, the user application 105A may be a web browser application (e.g., Microsoft Windows Internet Explorer, Mozilla Firefox, Apple Safari, Google Chrome, Opera, etc.). In an embodiment, the user application 105A is a special-purpose client application (e.g., Facebook for iPhone or iPad, etc.), and in an embodiment the user application 105A is the native operating system of the user device 104A, such as Windows®, Mac OSX®, IOS®, or ANDROID™, which may utilize an Application Programming Interface (API) to directly interface with the social networking system 130 through API request server 125.

The user devices 104A-104N are configured to communicate with the social networking system 130 via a network 121 or collection of networks—such as the Internet, a corporate Intranet, a Virtual Private Network (VPN), a Local Area Network (LAN), a Wireless Local Area Network (WLAN), a cellular network, a Wide Area Network (WAN), a Metropolitan Area Network (MAN), or a combination of two or more such networks. The network 121 may be wired, wireless, or a combination of both. In one embodiment, the network 121 uses standard communications technologies and/or protocols. Thus, the network 121 may include links using technologies such as Ethernet, Institute of Electrical and Electronics Engineers (IEEE) 802.11, Worldwide Interoperability for Microwave Access (WiMAX), 3G, 4G, Long Term Evolution (LTE), Code-Division Multiple Access (CDMA), Digital Subscriber Line (DSL), cable modems, etc. Similarly, the networking protocols used on the network 121 may include Multiprotocol Label Switching (MPLS), Transmission Control Protocol (TCP), Internet Protocol (IP), TCP/IP, User Datagram Protocol (UDP), Hypertext Transport Protocol (HTTP), Simple Mail Transfer Protocol (SMTP), and/or File Transfer Protocol (FTP). Data exchanged over the network 121 may be represented using technologies and/or formats including Hypertext Markup Language (HTML), Extensible Markup Language (XML), or JavaScript Object Notation (JSON), among other formats. In addition, all or some of links can be encrypted using conventional encryption technologies such as Secure Sockets Layer (SSL), Transport Layer Security (TLS), or Internet Protocol security (IPsec).

The social networking system 130 fundamentally relies upon information representing its users 102A-102N and a set of objects. Users 102A-102N, using the social networking system 130, may add connections to other users or objects of the social networking system 130 to which they desire to be connected, and may also interact with these other users or objects. The users of the social networking system 130 are individuals (e.g. humans), and the objects may include entities (such as businesses, organizations, universities, manufacturers, brands, celebrities, etc.), concepts, or other non-human things including but not limited to a location, an album, an article, a book, a concept, etc.

In some embodiments, the social networking system 130 also allows users to interact with external (e.g., third-party) applications 150 (e.g., websites), external storage 155, and/or external servers 115 (e.g., server end stations).

Based on the stored data about users, objects, and the connections between the users and/or objects, the social networking system 130 generates and maintains a “social graph” in a social graph store 140 comprising a plurality of nodes interconnected by a plurality of edges. Each node in the social graph represents a user or object that can act on another node and/or that can be acted on by another node. An edge between two nodes in the social graph represents a particular kind of connection between the two nodes, which may result from an action that was performed by one of the nodes on the other node. For example, when a user identifies an additional user as a friend, an edge in the social graph is generated connecting a node representing the first user and an additional node representing the additional user. The generated edge has a connection type indicating that the users are friends. As various nodes interact with each other, the social networking system 130 adds, removes, or otherwise modifies edges connecting the various nodes to reflect the interactions.

To provide these functionalities, the embodiment of the social networking system 130 includes an API request server 125, a web server 123, a message server 124, an action logger 126, and a set of data stores 101. This embodiment also includes, within the data stores 101, a social graph store 140 including a node store 142 and an edge store 144, as well as a content store 146, an action log 148, a user profile data store 152, and an object data store 154. In other embodiments, the social networking system 130 may include additional, fewer, or different modules for various applications. Of course, conventional components such as processors, memories, security mechanisms, load balancers, failover servers, management and network operations consoles, and the like are not shown in FIG. 1 so as to not obscure the details of the system.

The social networking system 130 allows its users 102A-102N to communicate or otherwise interact with each other and access content, as described herein. The social networking system 130 stores user profiles in the user profile data store 152. A user profile includes declarative information about the user that was explicitly shared by the user, and may also include profile information inferred by the social networking system 130. In one embodiment, a user profile includes multiple data fields, each data field describing one or more attributes of the corresponding user of the social networking system 130. The user profile information stored in user profile data store 152 describes the users 102A-102N of the social networking system 130, including biographic, demographic, and other types of descriptive information, such as work experience, educational history, gender, relationship status, hobbies, location, other preferences, and the like. The user profile may also store information provided by the user. For example, images or videos provided by the user may also be stored within the user profile. In other embodiments only textual data of the user is stored in the user profile and other data (e.g., images, videos) are stored in multimedia stores and associated with the user (e.g., through associating a user identifier of the user with an image/video identifier of the multimedia content). In certain embodiments, images or videos including or depicting users of the social networking system 130 may be “tagged” with identification information of those users. A user profile in the user profile data store 152 may also maintain references to actions (stored in the user profile or in an action log 148) by the corresponding user performed on content items in a content store 146 and stored in an edge store 144. A user may also specify one or more privacy settings, which are stored in that user's user profile. Privacy settings limit information that the social networking system 130 or other users of the social networking system 130 are permitted to access from that user's user profile.

The web server 123 links the social networking system 130 via the network 121 to one or more user devices 104A-104N by accepting requests for from the user devices 104A-104N and/or transmitting web pages or other web-related content to the user devices 104A-104N, such as image files, audio files, video files, Java applets, Flash, XML, JavaScript, Cascading Style Sheets (CSS), and so forth. The web server 123 in some embodiments is configured to utilize a set of one or more network interfaces 127 to send and receive messages across the network 121. In some embodiments the web server 123 (additionally or alternately) utilizes a message server 124 (e.g., a dedicated server end station, a dedicated software application, etc.) to communicate with the user devices 104A-104N, which is operative to send and/or receive instant messages, queued messages (e.g., email), text and SMS (Short Message Service) messages, or utilize any other suitable messaging technique.

In some embodiments, a message sent by a user to another user by way of the social networking system 130 can be viewed by other users of the social networking system 130, for example, by certain connections of the user (directly connected users in the social graph, other users more than one hop away in the social graph, etc.) receiving the message. An example of a type of message that can be viewed by other users of the social networking system 130 (besides the recipient of the message) is commonly known as a wall post. In some embodiments, a user can send a private message to another user that can only be retrieved by the other user. These messages are stored in storage such as message store 1

When a user takes an action within the social networking system 130, the action may be recorded in an action log 148 by an action logger 126, subject to any privacy settings and restrictions of the user and/or social networking system 130. In one embodiment, the social networking system 130 maintains the action log 148 as a database of entries. When an action is taken on the social networking system 130, the social networking system 130 can add an entry for that action to the action log 148. In accordance with various embodiments, the action logger 126 is capable of receiving communications from the web server 123 about user actions on and/or off the social networking system 130. The action logger 126 populates the action log 148 with information about those user actions. This information may be subject to privacy settings associated with the user. Any action that a particular user takes with respect to another user is associated with each user's profile, through information maintained in a database or other data repository, such as the action log 148. Examples of actions taken in the social networking system 130 that may be stored in the action log 148 include, but are not limited to, adding a connection to another other user, sending a message to the other user, reading a message from the other user, viewing content (e.g., wall posts, images, videos) associated with or created by the other user, attending an event posted by another user, being tagged in photos with another user, etc. In some embodiments, certain actions are described in connection with more than one user, and these actions may be associated with those users as well and stored in the action log 148.

The action log 148 may be used by the social networking system 130 to track other user actions on the social networking system 130, as well as actions on an external application 150 (e.g., website) that are communicated to the social networking system 130. Users may interact with various objects on the social networking system 130, including commenting on posts, sharing links, and checking-in to physical locations via a mobile device, accessing content items in a sequence or other interactions. Information describing these actions is stored in the action log 148. Additional examples of interactions with objects on the social networking system 130 included in the action log 148 include logging in to the social networking system 130, commenting on a photo album, communications between users, becoming a fan of a musician or brand by “liking” a page of the respective entity, adding an event to a calendar, joining a group, creating an event, authorizing an application, using an application, and engaging in a transaction. Additionally, the action log 148 records a user's interactions with advertisements on the social networking system 130 as well as other applications operating on the social networking system 130. In some embodiments, data from the action log 148 is used to infer interests or preferences of the user, augmenting the interests included in the user profile and allowing a more complete understanding of user preferences.

The API request server 125 allows external systems (e.g., an external application 150 of external server 115, and/or user applications 105A of user devices 104A-104N) to access information from or transmit information to the social networking system 130 by issuing API calls. The information provided by the social networking system 130 may include user profile information or the connection information of users, subject to the individual privacy settings of the user. For example, a system (e.g. external application 150) may send an API request to the social networking system 130 via the network 121 to publish a story on behalf of a user, request information about a user (after having been given permission to do so by the user), upload a photograph on behalf of a user, etc. API requests are received at the social networking system 130 by the API request server 125, which then processes the request by performing actions sought by the API requests, determining appropriate responses to the API requests, and transmitting back these responses back to the requesting application 150 via the network 121.

The content store 146 stores content items associated with user profiles, such as posts, images, videos, and/or audio files. Content items from the content store 146 may be displayed when a user profile is viewed or when other content associated with the user profile is viewed. For example, displayed content items may show images or video associated with a user profile or show text describing a user's status. Additionally, other content items may facilitate user engagement by encouraging a user to expand his connections to other users or entities, to invite new users to the system or to increase interaction with the social network system 130 by displaying content related to users, objects, activities, or functionalities of the social networking system 130. Examples of social networking content items include suggested connections or suggestions to perform other actions, media provided to or maintained by the social networking system 130 (e.g., pictures, videos), status messages or links posted by users to the social networking system, events, groups, pages (e.g., representing an organization or commercial entity), and any other content provided by, or accessible via, the social networking system 130.

The content store 146 also includes one or more pages associated with entities included social graph store 140. An entity is a type of object that can be a non-individual user of the social networking system 130, such as a business, a vendor, an organization, or a university. However, in some embodiments of the invention, an entity may represent a celebrity or other well-known individual, and thus an entity object node for a person may exist in the social graph (serving as a “brand” for that individual, and perhaps having an associated page that other users may “like”) and also a user node for that same person may also exist in the social graph (serving as a representation for a personal account of that person). A page includes content associated with an entity and instructions for presenting the content to a user of the social networking system 130. For example, a page identifies content associated with the entity's stored content (from the object data store 154) as well as information describing how to present the content to users viewing the page.

In the depicted embodiment, the social networking system 130 includes an administrator tool highlight engine 129 to be executed on a processor of the social networking system 130. The administrator tool highlight engine 129 performs one or more functions for highlighting an administrator tool to a user (such as an administrator) of the social networking system 130. For example, the administrator tool highlight engine 129, in some embodiments, evaluates one or more signals such as those related to a social networking page (e.g., category, country, locale, fan count, how long the page has existed, etc.), the administrator's behavior (e.g., date of last visit, frequency of visits, previous tool(s) used, historical performance of action(s) taken by the administrator), and/or the user base (e.g., demographics, historical reaction to actions/content, etc.) to determine an available administrator tool to highlight to the user. In some embodiments, the administrator tool highlight engine 129 highlights an administrator tool based on explicit input from the admin such as an action to take place or an objective.

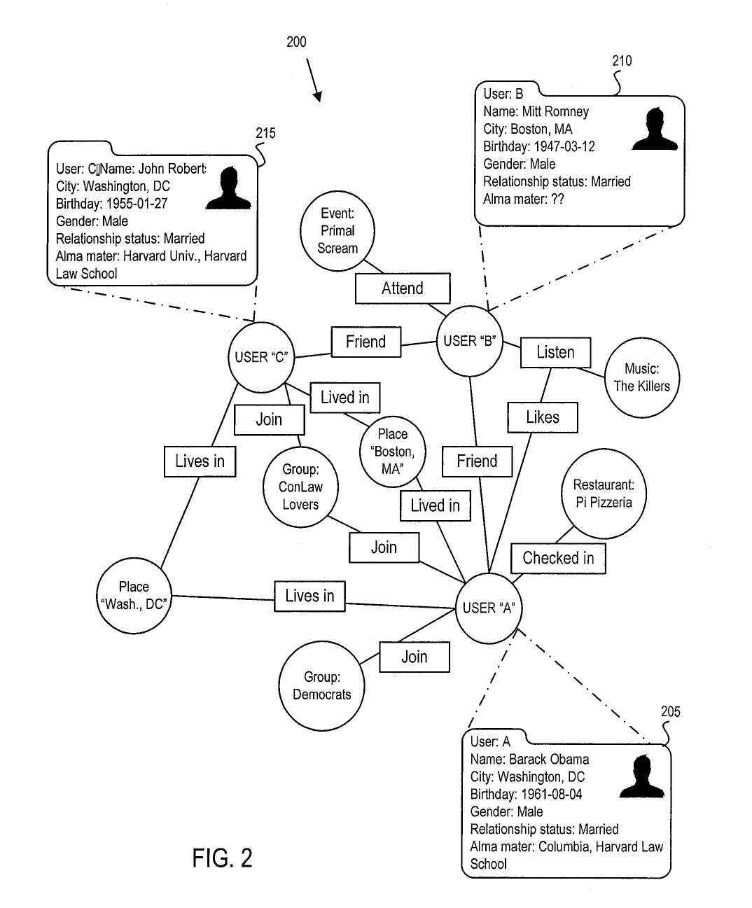

FIG. 2 illustrates an exemplary graph 200 of social network data. In graph 200, objects are illustrated as circles and actions are illustrated as labeled connections between circles. Developers of the social network or corresponding social network applications define actions to represent different ways that users may interact with the social network and/or their applications. As users perform actions, connections are made between users and objects. For example, User A has performed a number of actions within the social network, indicating that he previously lived in Boston, currently lives in Washington D.C., joined groups for Democrats and ConLaw Lovers, is following the White Sox, and is friends with User B. User B and User C have also performed a number of actions with respect to objects within graph 200.

In one embodiment, users are able to add demographic information to user profiles 205-215. In one embodiment, for demographic information that has not been entered by a user, a social network application generates an estimate based upon the user's actions, connections, and/or actions of connections. For example, User B has not entered an alma mater into user profile 210. A social network application may determine from User B's contacts, activities, cities of residence, etc. that User B's likely alma mater is one or both of Brigham Young University and Harvard University. In one embodiment, the user profiles 205-210 include additional information, such as relationships to other users, places where the user has worked, user interests, etc.

In one embodiment, users are able to provide feedback on actions of other users/entities. As a result, actions are also viewed as objects that may be acted upon. For example, User B listened to music by the artist, The Killers. As a result, the social networking system publishes a narrative associated with User B (e.g., in a newsfeed, profile of User B, etc.) indicating that User B listened to music by the artist, The Killers. In viewing a newsfeed, profile of User B, or another form of social networking system publication(s), the social networking system displays the narrative to User A. The social networking system then receives input from User A indicating that User A “likes” that User B listened to The Killers.

In one embodiment, demographic data further includes a weight or score indicating an affinity between a user and an object. For example, repeated user action with one object may indicate a stronger affinity for said object than another object with which the user has limited interaction. First degree connections, e.g., the friendship between User A and User B, may indicate a stronger affinity than second degree connections, e.g., User A is friends with User B, who is friends with User C, creating a second degree connection between User A and User C. An indication that two users are married may indicate a stronger affinity than if two users are friends. Additionally, temporal and geographic proximity of actions/users are other exemplary indicators of affinity.

In one embodiment, users may select privacy settings to control what network service data is shared, with whom the data is shared, and/or what data used for selecting candidate objects.

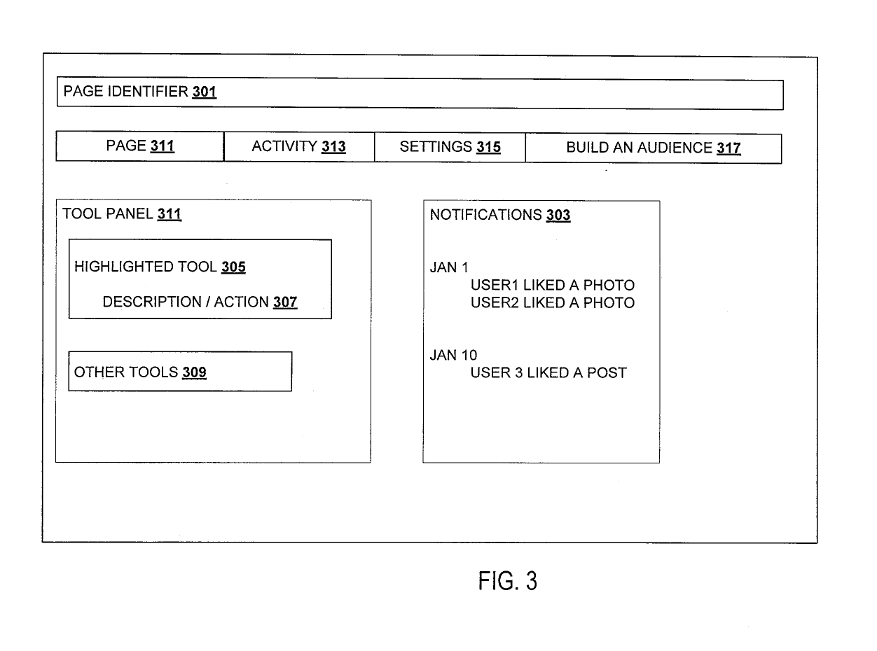

As briefly discussed above, in some embodiments, a social networking system highlights an administrator tool in a graphical user interface (GUI) for an administrator of a page. Typically, this is done by the administrator tool highlight engine 129. FIG. 3 illustrates an embodiment of a GUI of a page provided by a social networking system to a user. The user that views this page has administrative rights such that he/she may edit the page and content published on behalf of the page.

In this GUI, a page identifier 301 indicates which page the user is looking at. In some instances, an administrator has control over multiple pages and would use this identifier 301 to determine which page he/she is viewing at that time.

An administrator tool panel 311 provides the user of the page with access (e.g., links) to one or more administrator tools such as: 1) get more social interaction (e.g., likes, reposts, comments, etc.); 2) invite a friend; 3) invite email contacts; and 4) share the page. Depending on the implementation, the content of the administrator tool panel 311 varies. In some embodiments, a highlighted administrator tool 305 is shown and other administrator tools 309 are not. In other embodiments, a highlighted administrator tool 305 is shown more prominently (e.g., at the top of a list of tools, a different color than the other tools, and/or in a larger font than the other tools, etc.) than other available administrator tools 309 which are also shown. These administrator tools should help a user achieve objectives such as building or identifying an audience (e.g., the invite a friend tool may help with this), reaching an audience, and/or custom objectives such as converting page views into donations or sales.

In some embodiments, the highlighted administrator tool 305 includes not only access to the administrator tool, but also a description of it and available actions associated with it. This descriptive content may be provided near the highlighted administrator tool 305 (such as beneath it) or as a pop-up when the user hovers over the administrator tool 305. Other administrator tools 309 may have similar descriptive available to the user in the GUI.

Additionally, in some embodiments, the GUI includes notifications 303 regarding interactions with past posts such as user's liking a post, photo, etc. Of course, post content, etc. may also be provided.

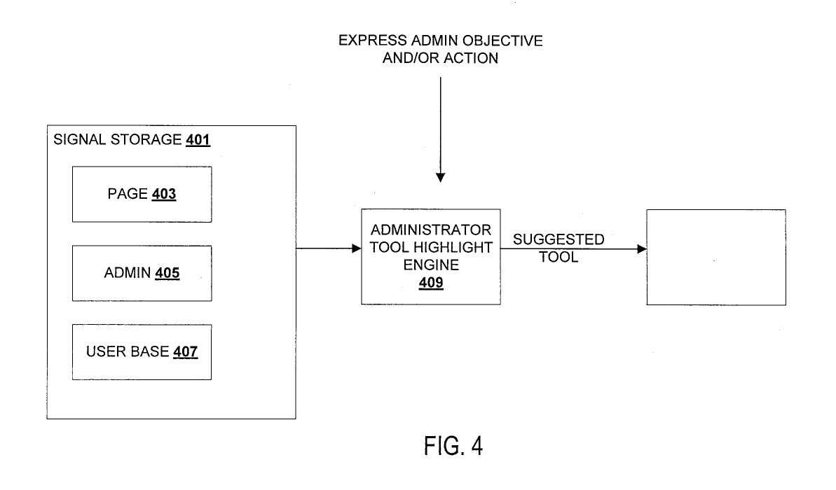

FIG. 4 illustrates an exemplary block diagram of a social networking system and its administrator tool highlight engine. This administrator tool highlight engine 409 is, for example, administrator tool highlight engine 129 discussed above.

In most embodiments, the administrator tool highlight engine 409 takes in one or more signals and uses those signals in its determination of a highlighted administrator tool that is provided to a GUI 411 as detailed above. These signals are normally found in storage 401 such as content store 146 and social graph store 140. These signals are related to a social networking page (e.g., category, country, locale, fan count, how long the page has existed, etc.), the administrator's behavior (e.g., date of last visit, frequency of visits, previous tool(s) used, historical performance of action(s) taken by the administrator), and/or the user base (e.g., demographics, historical reaction to actions/content, etc.) to determine an available tool to highlight to the user.

In some embodiments, the administrator tool highlight engine 409 highlights an administrator tool based on express input from the user such as an action to take place or an objective. For example, based upon an express objective of adding new followers, the administrator tool highlight engine 409 may suggest invite email contacts. In doing so, the administrator tool highlight engine 409 will take into account stored signals such as the page's user base 407 and not highlight this tool if all email contacts are already followers. In some embodiments, the express objective and/or action is selectable from a fixed list by the administrator. For example, an express objective is presented as a part of a dropdown menu to the administrator. In other embodiments, objectives and/or actions are typed in.

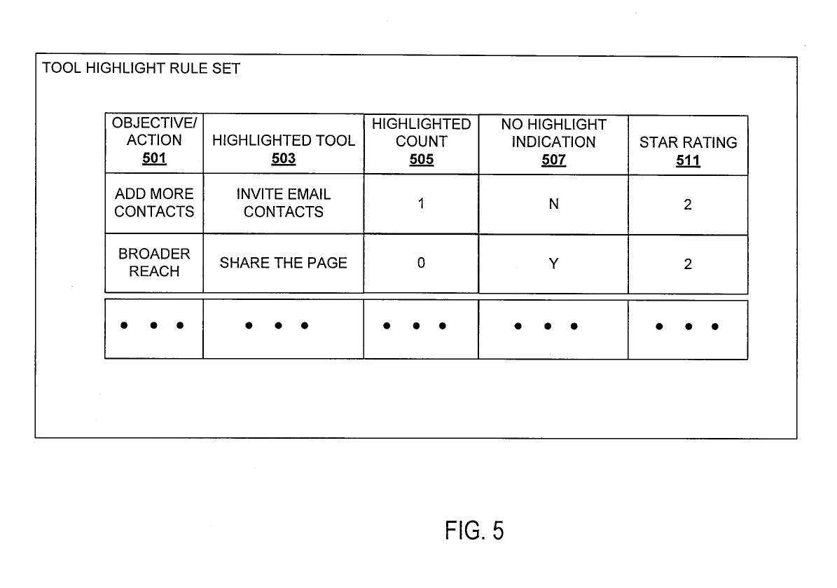

In some embodiments, the administrator tool highlight engine 409 utilizes an administrator tool highlight rule set. In this rule set objectives and/or actions are mapped to tools. FIG. 5 illustrates an embodiment of an administrator tool highlight rule set. In this example, an objective and/or action 501 is mapped to at least one highlighted administrator tool 503. However, as shown, an objective and/or action may have multiple administrator tool highlights associated with it.

In addition to the objective and/or action to administrator tool highlight mapping, in some embodiments the rule set includes counts to track a number of times that a highlighted administrator tool has been highlighted to a user 505. A highlight count 505 tracks a number of times that a particular administrator tool has been highlighted to the posting user. For example, after a highlight has been used the count value is incremented. In some embodiments, instead of a numerical count value, all that is recorded in the rule set is an indication that a highlight has been used.

In some embodiments, an indication of if a highlight should be shown to the user 507 is stored in the rule set. For example, when a user as indicated that either that particular highlight is not desirable or that all highlights are not desirable is stored such that a particular highlight or all highlights will not be provided by the social networking system.

In some embodiments, the rule set also includes a rating 511 per highlight. This rating is provided by the posting user upon viewing the highlight. These ratings may be used by the social networking system in determining which highlights to provide to a user, class of users (those will similar characteristics such as location, business type, etc.), or users social networking system-wide.

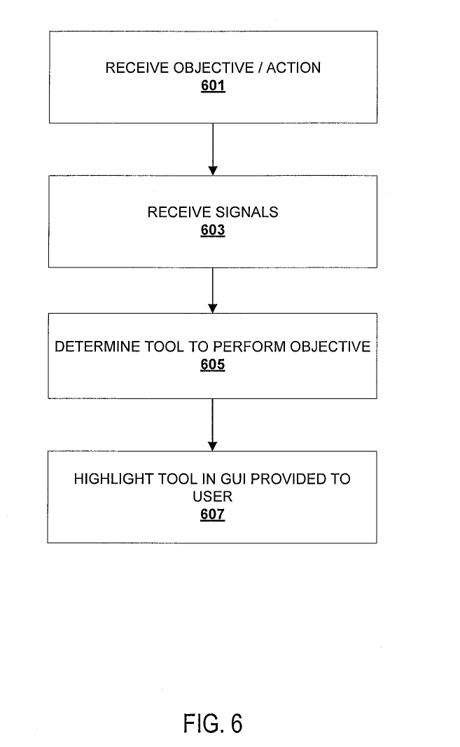

FIG. 6 illustrates an embodiment of a method executed by a social networking system for providing administrator tool highlights to a user. Typically, this method is performed by an administrator tool highlight engine such as that detailed earlier. It is also assumed that a decision on whether or not the user should receive highlights has already been made.

At 601, the social networking system receives an objective or action from a user according to some embodiments. As noted above, objectives or actions may be selected from a list or typed in.

Signals, such as those detailed above, are received at 603. An administrator tool to highlight (suggest) is determined using one or more of the received signals and/or an objective or action at 605 as discussed above. The determined administrator tool is provided to the user via a GUI at 607.

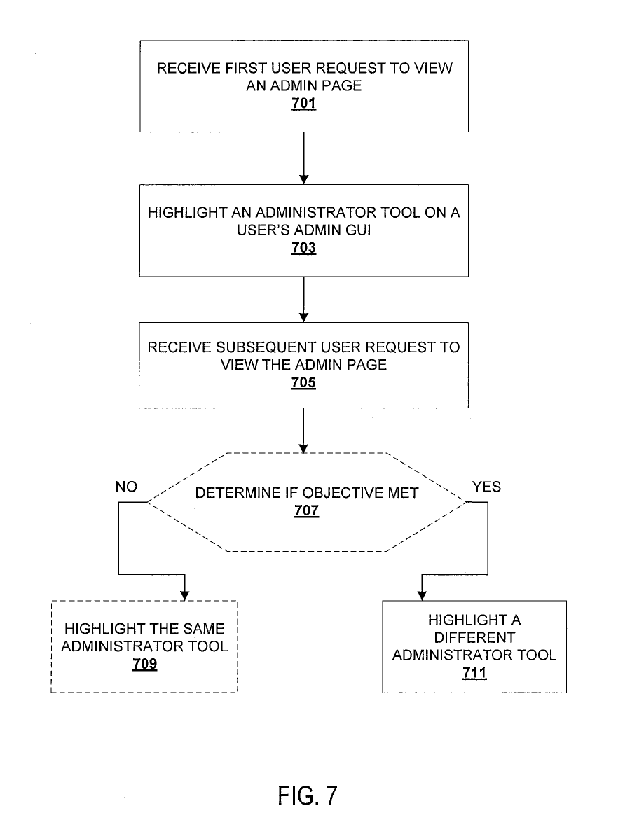

FIG. 7 illustrates an embodiment of a method executed by a social networking system for providing administrator tool highlights. Typically, this method is performed by an administrator tool highlight engine such as that detailed earlier. It is also assumed that a decision on whether or not the user should receive highlights has already been made.

At 701, the social networking system receives a first user request to view an administrative page associated with the user. This page a typically associated with an entity such as a business, celebrity, etc.

An administrator tool is highlighted on the user's administrative page at 703. This administrator tool is determined by the administrator tool highlight engine using signals, objectives, and/or actions as detailed above. This administrator tool may be highlighted by not showing other tools, being in a different font, size, or color than other tools, being the first shown tool, etc. This could be, for example, the highlighted tool provided via a GUI at 607.

At 705 the social networking system receives a second user request to view the administrative page associated with the user.

In some embodiments, a determination of if the administrator's objective has been met is made at 707. For example, the administrator tool highlight engine may look to see if the user has successfully added more followers, etc. In some embodiments, the user provides an indication of success or failure of the objective.

When the objective is not met, then in some embodiments the same administrator tool is highlighted and provided at 709.

In some embodiments, when the objective is met, or if the determination is not made in the first place, a different administrator tool is highlighted and provided at 711.

While the above method embodiments have detailed providing highlights for an administrator tool, in some embodiments, tool highlight is much simpler. In these embodiments, a different tool is highlighted each time the user views the administrative page. For example, upon a first visit a first tool is highlighted and upon a subsequent visit a second tool is highlighted. This process of cycling through tools may be refined to include variants such as mixing up the order of tools highlighted, etc.

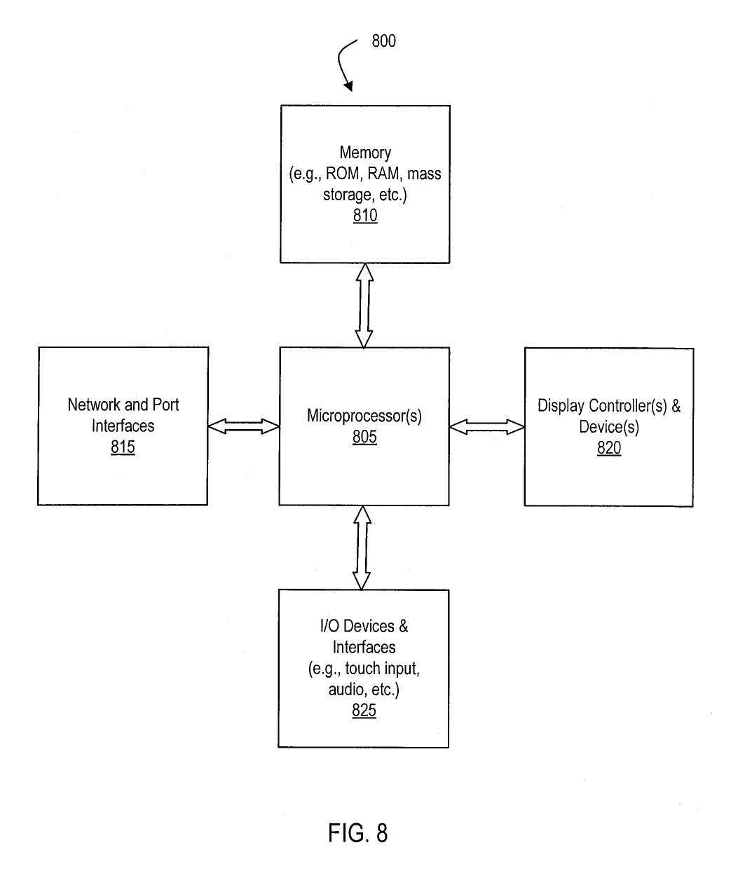

FIG. 8 illustrates, in block diagram form, an exemplary processing system to perform administrator tool highlighting. In some embodiments, this is a high-level view of social networking system 1130 described herein. Data processing system 800 includes one or more microprocessors 805 and connected system components (e.g., multiple connected chips). Alternatively, data processing system 800 is a system on a chip.

Data processing system 800 includes memory 810, which is coupled to microprocessor(s) 805. Memory 810 may be used for storing data, metadata, and programs for execution by the microprocessor(s) 805 including the modules and engines detailed above. For example, memory 810 may include one or more of the data stores 101 and/or may store modules described herein. Memory 810 may include one or more of volatile and non-volatile memories, such as Random Access Memory (“RAM”), Read Only Memory (“ROM”), a solid state disk (“SSD”), Flash, Phase Change Memory (“PCM”), or other types of data storage. Memory 810 may be internal or distributed memory.

Data processing system 800 includes network and port interfaces 815, such as a port, connector for a dock, or a connector for a USB interface, FireWire, Thunderbolt, Ethernet, Fibre Channel, etc. to connect the system 800 with another device, external component, or a network. Exemplary network and port interfaces 815 also include wireless transceivers, such as an IEEE 802.11 transceiver, an infrared transceiver, a Bluetooth transceiver, a wireless cellular telephony transceiver (e.g., 2G, 3G, 4G, etc.), or another wireless protocol to connect data processing system 800 with another device, external component, or a network and receive stored instructions, data, tokens, etc.

Data processing system 800 also includes display controller and display device 820 and one or more input or output (“I/O”) devices and interfaces 825. Display controller and display device 820 provides a visual user interface for the user. I/O devices 825 allow a user to provide input to, receive output from, and otherwise transfer data to and from the system. I/O devices 825 may include a mouse, keypad or a keyboard, a touch panel or a multi-touch input panel, camera, optical scanner, audio input/output (e.g., microphone and/or a speaker), other known I/O devices or a combination of such I/O devices.

It will be appreciated that one or more buses, may be used to interconnect the various components shown in FIG. 8.

Data processing system 800 may be a personal computer, tablet-style device, a personal digital assistant (PDA), a cellular telephone with PDA-like functionality, a Wi-Fi based telephone, a handheld computer which includes a cellular telephone, a media player, an entertainment system, or devices which combine aspects or functions of these devices, such as a media player combined with a PDA and a cellular telephone in one device. In other embodiments, data processing system 800 may be a network computer, server, or an embedded processing device within another device or consumer electronic product. As used herein, the terms computer, device, system, processing system, processing device, and “apparatus comprising a processing device” may be used interchangeably with data processing system 800 and include the above-listed exemplary embodiments.

Additional components, not shown, may also be part of data processing system 800, and, in certain embodiments, fewer components than that shown in FIG. 8 may also be used in data processing system 800. It will be apparent from this description that aspects of the inventions may be embodied, at least in part, in software. That is, the computer-implemented method(s) detailed above may be carried out in a computer system or other data processing system 800 in response to its processor or processing system 805 executing sequences of instructions contained in a memory, such as memory 810 or other non-transitory machine-readable storage medium. The software may further be transmitted or received over a network (not shown) via network interface device 815. In various embodiments, hardwired circuitry may be used in combination with the software instructions to implement the present embodiments. Thus, the techniques are not limited to any specific combination of hardware circuitry and software, or to any particular source for the instructions executed by data processing system 800.

An article of manufacture may be used to store program code providing at least some of the functionality of the embodiments described above. Additionally, an article of manufacture may be used to store program code created using at least some of the functionality of the embodiments described above. An article of manufacture that stores program code may be embodied as, but is not limited to, one or more memories (e.g., one or more flash memories, random access memories—static, dynamic, or other), optical disks, CD-ROMs, DVD-ROMs, EPROMs, EEPROMs, magnetic or optical cards or other type of non-transitory machine-readable media suitable for storing electronic instructions. Additionally, embodiments of the invention may be implemented in, but not limited to, hardware or firmware utilizing an FPGA, ASIC, a processor, a computer, or a computer system including a network. Modules and components of hardware or software implementations can be divided or combined without significantly altering embodiments of the invention.

It will be evident that various modifications may be made thereto without departing from the broader spirit and scope of the invention as set forth in the following claims. For example, the methods described herein may be performed with fewer or more features/blocks or the features/blocks may be performed in differing orders. Additionally, the methods described herein may be repeated or performed in parallel with one another or in parallel with different instances of the same or similar methods.

What is claimed is:

1. A computer-implemented method comprising:
receiving a plurality of signals, at an administrator tool highlighting engine executing on a hardware processor, relating to at least one of a social networking page, behavior of an administrator of the page, and a user base of the page;
determining an administrator tool to highlight based on the signals;
generating a graphical user interface highlighting the administrator tool; and
providing the graphical user interface to a user.

2. The computer-implemented method of claim 1, further comprising:
receiving an express objective, wherein the determining an administrator tool to highlight based on the signals and the express objective.

3. The computer-implemented method of claim 1, wherein the signals relating to the page comprise one or more of category, country, locale, fan count, and how long the page has existed.

4. The computer-implemented method of claim 1, wherein the signals relating to the behavior of the administrator of the page comprise one or more of date of last visit, frequency of visits, previous tools used, and historical performance of action taken by the administrator.

5. The computer-implemented method of claim 1, wherein the signals relating to the user base of the page comprise one or more of demographics and historical reaction to actions/content.

6. The computer-implemented method of claim 1, wherein the administrator tool is highlighted by making it a different color than other administrator tools shown on the graphical user interface.

7. The computer-implemented method of claim 1, wherein the administrator tool is highlighted by making it a different font than other administrator tools shown on the graphical user interface.

8. The computer-implemented method of claim 1, wherein the administrator tool is highlighted by not showing other administrator tools on the graphical user interface.

9. The computer-implemented method of claim 1, wherein the graphical user interface is for an activity portion of an administrator graphical user interface.

10. A non-transitory computer-readable medium storing instructions which, when executed by one or more processors in a processing device, cause the processing device to perform a method comprising:
receiving a plurality of signals, at an administrator tool highlighting engine executing on a hardware processor, relating to at least one of a social networking page, behavior of an administrator of the page, and a user base of the page;
determining an administrator tool to highlight based on the signals;
generating a graphical user interface highlighting the administrator tool; and
providing the graphical user interface to a user.

11. The non-transitory computer-readable medium of claim 10, further comprising:
receiving an express objective, wherein the determining an administrator tool to highlight based on the signals and the express objective.

12. The non-transitory computer-readable medium of claim 10, wherein the signals relating to the page comprise one or more of category, country, locale, fan count, and how long the page has existed.

13. The non-transitory computer-readable medium of claim 10, wherein the signals relating to the behavior of the administrator of the page comprise one or more of date of last visit, frequency of visits, previous tools used, and historical performance of action taken by the administrator.

14. The non-transitory computer-readable medium of claim 10, wherein the administrator tool is highlighted by making it a different color than other administrator tools shown on the graphical user interface.

15. An apparatus comprising:
a memory to store instructions;
a hardware processing device to execute the stored instructions to cause the apparatus to:
receive a plurality of signals, at an administrator tool highlighting engine executing on a hardware processor, relating to at least one of a social networking page, behavior of an administrator of the page, and a user base of the page;
determine an administrator tool to highlight based on the signals;
generate a graphical user interface highlighting the administrator tool; and
provide the graphical user interface to a user.

16. The apparatus of claim 15, wherein the hardware processing device to further:
receive an express objective, wherein to determine an administrator tool to highlight based on the signals and the express objective.

17. The apparatus of claim 15, wherein the signals relating to the page comprise one or more of category, country, locale, fan count, and how long the page has existed.

18. The apparatus of claim 15, wherein the signals relating to the behavior of the administrator of the page comprise one or more of date of last visit, frequency of visits, previous tools used, and historical performance of action taken by the administrator.

19. The apparatus of claim 15, wherein the signals relating to the user base of the page comprise one or more of demographics and historical reaction to actions/content.

20. The apparatus of claim 15, wherein the administrator tool is highlighted by making it a different color than other administrator tools shown on the graphical user interface.
